(19) United States
(12) Patent Application Publication
(10) Pub. No.: US 2007/0244925 A1
(43) Pub. Date: Oct. 18, 2007

(54) Intelligent image searching

(76) Inventor: Jean-Francois Albouze, Boulder Creek, CA (US)

Correspondence Address: FISH & RICHARDSON P.C., PO BOX 1022, MINNEAPOLIS, MN, 55440-1022, US

(21) Appl. No.: 11/403,643

(22) Filed: Apr. 12, 2006

(51) Int. Cl. G06F 7/00

(52) U.S. Cl. 707/104.1

(57) ABSTRACT

Methods and apparatus, including computer program products, for receiving a query and determining a first plurality of images using a first search technique and based on the query, each image in the first plurality of images being associated metadata. Identifying metadata based on the query. And analyzing associated metadata for each image in the first plurality of images based on the identified metadata to identify one or more second images.

### BACKGROUND

Conventional image searching and classification techniques allow users to search for images that satisfy a search query, such as nature images or images of buildings. Some conventional techniques analyze keywords and/or visual features of low resolution images (e.g., thumbnails) to quickly produce a set of candidate images. However, this can result in a large and less accurate set of candidate images than if high resolution images had been analyzed. Another approach is to compare low resolution images to a database of known scenes. This approach becomes more accurate as image resolution increases, but improved accuracy comes at the expense of longer search times.

### SUMMARY

In general, in one aspect, embodiments of the invention feature receiving a query and determining a first plurality of images using a first search technique and based on the query. Each image in the first plurality of images is associated with metadata. Metadata is identified based on the query. Associated metadata for each image in the first plurality of images is analyzed based on the identified metadata to identify one or more second images.

These and other embodiments can optionally include one or more of the following features. The metadata includes one or more of exposure settings, date, time, or location. The first search technique is Bayesian. The one or more second images are presented in a user interface. The query is text or speech. The query is an image. Metadata is incorporated into an associated image or is stored external to an associated image. It is determined whether each image in the first plurality of images occurs in a time-ordered series of similar images.

In general, in another aspect, embodiments of the invention feature a first plurality of images, each image in the first plurality of images being associated with metadata. A search engine is configured to receive a query and determine a second plurality of images from the first plurality of images using a first search technique and based on the query. An image metadata analyzer is configured to determine one or more third images from the second plurality of images based on analyzing metadata associated with the second plurality of images.

These and other embodiments can optionally include one or more of the following features. The image metadata analyzer is further configured to identify metadata based on the query.

In general, in another aspect, embodiments of the invention feature receiving a query and determining a set of images that satisfies the query using metadata associated with the images.

In general, in another aspect, embodiments of the invention feature receiving a query and determining a first set of candidate images using a first search technique. A second set of images that satisfy the query from the first set of candidate images is determined using metadata associated with the images.

Particular embodiments of the invention can be implemented to realize one or more of the following advantages. Large sets of images can be searched quickly by analyzing metadata associated with the images, alone or in combination with conventional search and classification techniques. The metadata that is analyzed is determined based on a textual or image-based query. Images that have no associated textual description information can be searched for using the query. Statistics and probabilities can be used to confirm or reject an image based on where the image occurs in a time ordered sequence of images. The number of positive hits can be improved over other traditional methods.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 is a diagram illustrating an image capture and upload process.

FIG. 2 illustrates a graphical user interface for image searching.

FIG. 3 is a flow diagram illustrating an exemplary query processing approach.

FIG. 4 is a block diagram of an exemplary query processing system.

Like reference numbers and designations in the various drawings indicate like elements.

### DETAILED DESCRIPTION

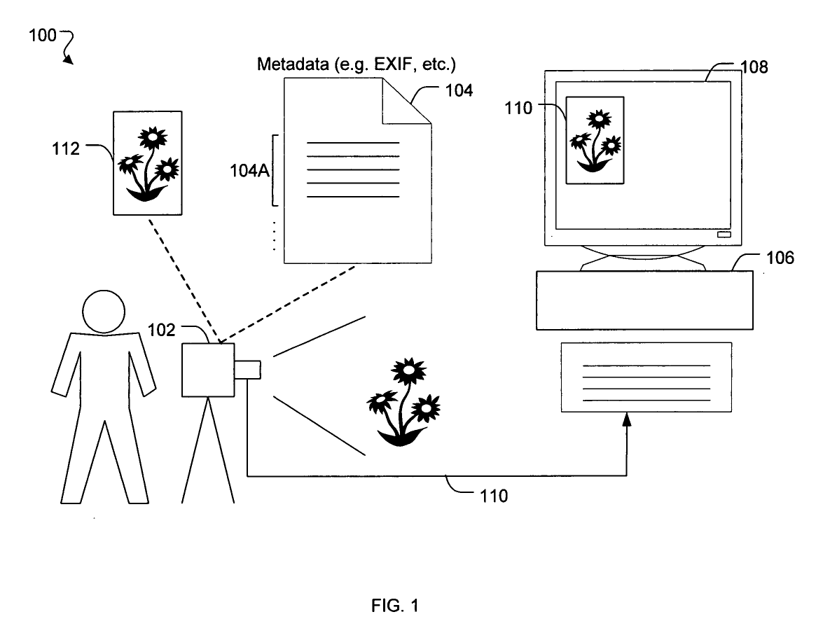

As shown in FIG. 1, users can capture still or continuous digital images (or “images”) using an image capture device 102 such as a digital camera or other device having digital image capture capability (e.g., a digital video camera, a cellular telephone, a mobile computing device, a smart phone, a portable electronic game device, combinations of these, or other suitable devices). Alternatively, images captured with non-digital devices (e.g., film cameras) can be converted into digital format using an image scanner, for example. Images include image data 112 and associated metadata 104. The image data 112 and the associated metadata 104 can be stored in one or more electronic files or memories. The metadata 104, or portions thereof, can also be obtained from sources external to the image capture device 102, such as a from web service, a database, a server, or other suitable sources. For example, such externally obtained metadata can include a weather report for the date and time at which the image data 112 was captured. Weather information can be used to search for images including rain or snow, for instance.

The image data 112 can include, for example, discrete pixels of digitally quantized brightness and color. The image data 112 and the metadata 104 can be compressed and encrypted. The metadata 104 can include information 104A associated with the capture of the image data 112, such as the geographic location of the image capture device 102 at the time of image capture, the date and time of image capture, the temperature or weather conditions, shutter speed (exposure), aperture width (F-stop), flash setting, film type, and other suitable information. Metadata 104 can also be included in header information associated with the image data 112. For example, one type of image header contains properties describing the pixel density, color density, color palette, and a thumbnail version of the image data 112. In one implementation, the image data 112 or the metadata 104 can be stored in one of the following formats: Exchangeable Image File format (EXIF), Tagged Image File Format (TIFF), Joint Photographic Experts Group (JPEG), Graphic Image Format (GIF), Portable Network Graphics (PNG), and Portable Document Format (PDF), combinations of these, or other suitable formats.

The image data 112 and the associated metadata 104 can be electronically transferred through one or more wired or wireless networks 110 or buses (e.g., FireWire®, USB, etc.) to another device 106, such as a personal computer, for example, having a means of display 108 that can be used to present the image data 110.

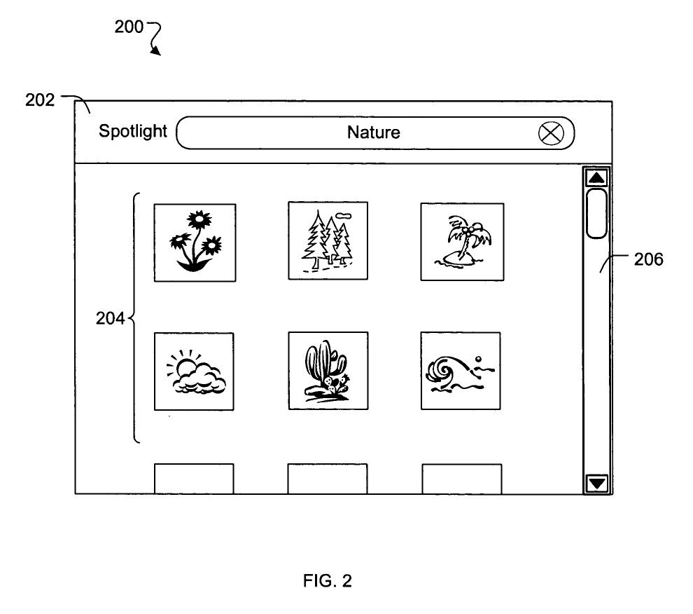

FIG. 2 illustrates a graphical user interface (GUI) 200 for image searching. The GUI 200 can be presented on display means 108 by an interactive search engine software tool, for instance, that allows users or processes to provide a query in the form of text, speech, or by specifying one or more target images to be used as the basis of the query (e.g., find images similar to the target image). A query can include one or more keywords or phrases, such as “nature” or “tall buildings”. A query can also include one or more Boolean, logical, or other operators to determine how keywords, phrases, or target images in the query are combined. For example, the query “outdoors and snow or rain” could be used to find images captured outdoors and featuring snow or rain. Alternatively, a query can be specified in natural language. A natural language query, for instance, could be posed as a sentence: “Find all images of beaches from last summer.”

The GUI 200 allows users to select images to search, modify search parameters such as how to sort and display the query results, and view query results. Searches can be performed locally on a single device or on multiple devices coupled to a network (e.g., remote image repositories). In one implementation, a local search can be initiated by the Spotlight file search engine for MAC OS X® operating system, available from Apple Computer, Inc. of Cupertino, Calif. An image search can locate a set of images that satisfy a query by utilizing metadata associated with image data. A search field 202 can be used to enter a query (e.g., the phrase “Nature”) or can be the target of a drag and drop of an image file for searching based on a target image. In one implementation, the image search first uses low resolution image data, for example the thumbnail metadata, to determine a set of candidate images using, for example, conventional search and classification techniques (e.g., Bayesian). Metadata 104 associated with the set of candidate images is then used to reduce the set of candidate images to a set of result images that satisfy the query. In some implementations, thumbnail representations 204 of the result set of images are presented in a view window in the user interface 200. A scroll bar 206 or other user interface element (e.g., button, etc.) may be used to view result images which do not fit within the view window.

The above approach uses metadata in a second stage of a multi-stage approach to image searching and classification. In a first stage, conventional techniques are applied to low resolution images with a more relaxed classification criteria to produce a set of candidate images. The use of low resolution images in the first stage can result in a set of candidate images containing a large number of images that do not satisfy the query. Metadata (e.g., EXIF data) associated with the images can be used to reduce the set of candidate images to a set of result images that satisfy the query.

The result images could be sorted based a variety of criteria, including by a timestamp metadata, file name, closest match, or other criteria. Alternatively, the GUI interface 200 can display scaled versions of result images on a map to indicate the location where each photo was taken. In a further alternative, the GUI 200 can place scaled versions of the result images on a timeline based on when each result image was captured. Other presentation implementations are possible, including combinations of these. The result images can also be provided to another software application, such as a slideshow presentation.

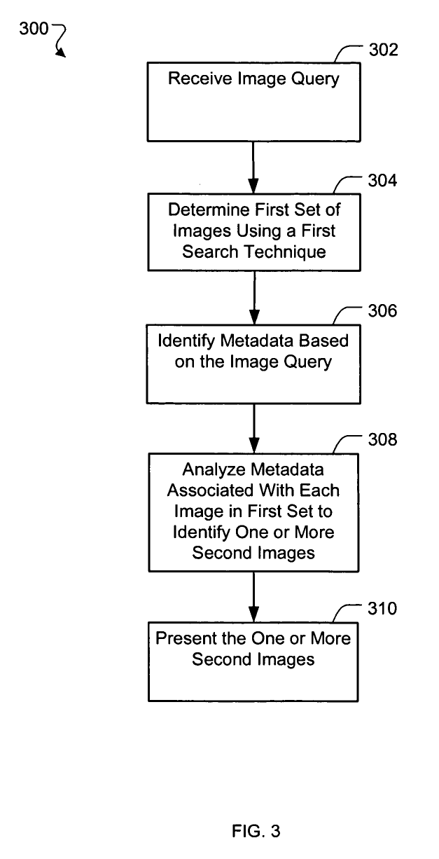

FIG. 3 is a flow diagram illustrating a query processing approach. A query is received (e.g., search field 202; step 302). An initial search technique determines a first set of candidate images (step 304). In one implementation, the initial search technique utilizes a low resolution image data and a mathematical probability classification approach such as a Bayesian methodology. However, other initial search techniques are possible. Bayesian logic is a style of inferential statistics that deals with probability inference. General composition characteristics of image categories can be stored and used to infer which of a set of searchable images may match terms in a query such as “mountain” or “beach”. By way of illustration, at the broadest level images may be classified as indoor or outdoor. Outdoor images can then be further characterized as urban or landscape. Landscape images may be broken into the subsets of sunset, forest, mountain, or beach scenes. Low resolution images containing a spiky collection of overlapping triangular shapes, for example, most likely identify mountains.

Metadata is identified based on the query (step 306). Words or phrases in the query are mapped to metadata that can be used to winnow down the first set of candidate images. For example, if the query called for a nature shot, images in the first set of candidate images having metadata indicating that the image data contained a nature shot would be selected. Such metadata could include a date of a summer month, an aperture with of F-stop 4.5, an exposure time of 1/171, and a film type of ISO 100. Other metadata is possible. Alternatively, if a target image is specified in query, the identified metadata can be based on metadata associated with the target image.

The metadata identified in step 306 is analyzed for each image in the first set of candidate images to identify a second set of images (step 308). In one implementation, each image in the first set of candidate images having metadata that is the same or similar to the metadata identified in step 306 is selected for the second set of images. The similarity of metadata can be based on distance in an attribute space, averages, probabilities, algorithms, or combinations thereof. In another implementation, statistics and probabilities can be used to further confirm or reject a candidate. For instance, in a sequence of five images (A, B, C, D, E) captured in chronological order and with short time intervals between them, if it can be determined that A, B, D & E are nature shots, then it is likely that C is a nature shot as well. The second set of images are presented as the final query result (e.g., in the GUI 200; step 310).

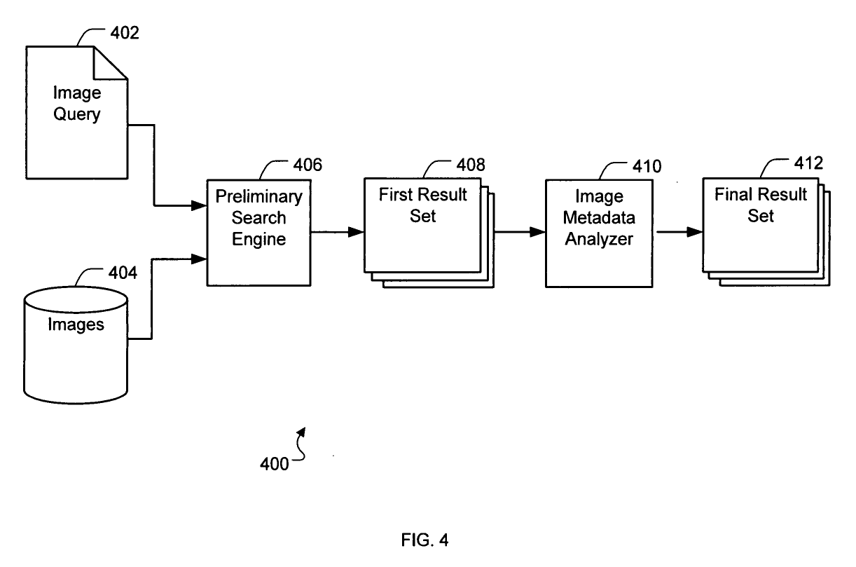

As shown in FIG. 4, a system 400 contains a persistent or non-persistent store of images 404. The system 400 can be implemented as software, firmware, hardware, or combinations thereof. Software and firmware for the system 400 can be distributed across one or more computing devices connected by one or more networks or other suitable means. The images 404 can incorporate both image data and associated metadata, and can be stored in one or more electronic files or memories on one or more computing devices, for example. The preliminary search engine 406 receives a query 402 and performs a first search technique based on the query 402, as described above, to generate a first result set of images 408. The first result set of images 408 is provided to an image metadata analyzer 410 which identifies metadata based on the query 402. The image metadata analyzer 410 then analyzes the metadata associated with each image in the first result set of images 408, based on the identified metadata, to yield a final result set of result images 412.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computer-implemented method, comprising:
receiving a query;
determining a first plurality of images using a first search technique and based on the query, each image in the first plurality of images being associated metadata;
identifying metadata based on the query; and
analyzing associated metadata for each image in the first plurality of images based on the identified metadata to identify one or more second images.

2. The computer-implemented method of claim 1, where:
the metadata includes one or more of exposure settings, date, time, or location.

3. The computer-implemented method of claim 1, where:
the first search technique is Bayesian.

4. The computer-implemented method of claim 1, further comprising:
presenting the one or more second images in a user interface.

5. The computer-implemented method of claim 1, where:
the query is text or speech.

6. The computer-implemented method of claim 1, where:
the query is an image.

7. The computer-implemented method of claim 1, where:
a metadata is incorporated into an associated image or is stored external to an associated image.

8. The computer-implemented method of claim 1, where analyzing further comprises:
identifying whether each image in the first plurality of images occurs in a time-ordered series of similar images.

9. A system comprising:
a first plurality of images, each image in the first plurality of images being associated with metadata;
a search engine configured to receive a query and determine a second plurality of images from the first plurality of images using a first search technique and based on the query; and
an image metadata analyzer configured to determine one or more third images from the second plurality of images based on analyzing metadata associated with the second plurality of images.

10. The system of claim 9, where:
the image metadata analyzer is further configured to identify metadata based on the query.

11. A computer-implemented method, comprising:
receiving a query; and
determining a set of images that satisfies the query using metadata associated with the images.

12. A computer-implemented method, comprising:
receiving a query;
determining a first set of candidate images using a first search technique; and
determining a second set of images that satisfy the query from the first set of candidate images using metadata associated with the images.

13. A computer program product, encoded on a computer-readable medium, operable to cause data processing apparatus to perform operations comprising:
determining a first plurality of images using a first search technique and based on a query, each image in the first plurality of images being associated metadata;
identifying metadata based on the query; and
analyzing associated metadata for each image in the first plurality of images based on the identified metadata to identify one or more second images.

14. The computer program product of claim 13, where:
the metadata includes one or more of exposure settings, date, time, or location.

15. The computer program product of claim 13, where:
the first search technique is Bayesian.

16. The computer program product of claim 13, further comprising:
presenting the one or more second images in a user interface.

17. The computer program product of claim 13, where:
the query is text or speech.

18. The computer program product of claim 13, where:
the query is an image.

19. The computer program product of claim 13, where:
a metadata is incorporated into an associated image or is stored external to an associated image.

20. The computer program product of claim 13, further operable to cause the data processing apparatus to perform operations comprising:
identifying whether each image in the first plurality of images occurs in a time-ordered series of similar images.
